(19) United States
(12) Patent Application Publication
(10) Pub. No.: US 2026/0161229 A1
(43) Pub. Date: Jun. 11, 2026

(54) INFORMATION PROCESSING DEVICE, INFORMATION PROCESSING METHOD, AND PROGRAM

(71) Applicant: SONY GROUP CORPORATION, TOKYO (JP)

(72) Inventors: TAHA MORIYAMA, TOKYO (JP); YUSUKE NAKAGAWA, TOKYO (JP); IKUO YAMANO, TOKYO (JP); HIROTO KAWAGUCHI, TOKYO (JP); AKIHITO NISHIIKE, TOKYO (JP); HIROSHI SUZUKI, TOKYO (JP)

(21) Appl. No.: 18/706,714

(22) PCT Filed: Sep. 22, 2022
(86) PCT No.: PCT/JP2022/035379

§ 371 Date: May 1, 2024

(30) Foreign Application Priority Data
Nov. 9, 2021 (JP) 2021-182548

(51) Int. Cl. G06F 3/01

(52) U.S. Cl. CPC G06F 3/016; G06F 3/014

(57) ABSTRACT

Provided are an information processing device, an information processing method, and a program capable of performing perception presentation more effectively. An information processing device including a control unit that performs perception presentation control according to contact with a virtual object, in which the control unit performs, as the perception presentation control, output of pressure sense presentation by a pressure sense presentation unit and output of force sense presentation by a force sense presentation unit at different timings for at least one part of a body.

### TECHNICAL FIELD

The present disclosure relates to an information processing device, an information processing method, and a program.

### BACKGROUND ART

As a device that presents a tactile sense and a force sense to a user in a case where a virtual object in a virtual space is held with a virtual hand, for example, Patent Document 1 below is disclosed. Patent Document 1 below describes that the fingertip is pressed by a movable portion (pointed member) movable by electromagnetic induction action to give a tactile stimulus, and a yarn attached to the fingertip is wound by a motor fixed to a frame to transmit a reaction force of a gripping force to give a force sense to the fingertip.

### CITATION LIST

### Patent Document

Patent Document 1: Japanese Patent Application Laid-Open No. 2016-24707

### SUMMARY OF THE INVENTION

### Problems to be Solved by the Invention

However, in Patent Document 1 described above, presentation of a tactile sense by pressing and presentation of a force sense are simultaneously performed, and it is not considered that the tactile sense becomes difficult to perceive due to the presentation of the force sense.

Accordingly, the present disclosure proposes an information processing device, an information processing method, and a program capable of performing perception presentation more effectively.

### Solutions to Problems

According to the present disclosure, there is proposed an information processing device including a control unit that performs perception presentation control according to contact with a virtual object, in which the control unit performs, as the perception presentation control, output of pressure sense presentation by a pressure sense presentation unit and output of force sense presentation by a force sense presentation unit at different timings for at least one part of a body.

According to the present disclosure, there is proposed an information processing method including a processor performing perception presentation control according to contact with a virtual object, and further performing, as the perception presentation control, output of pressure sense presentation by a pressure sense presentation unit and output of force sense presentation by a force sense presentation unit at different timings for at least one part of a body.

According to the present disclosure, there is proposed a program for causing a computer to function as a control unit that performs perception presentation control according to contact with a virtual object, the control unit performing, as the perception presentation control, output of pressure sense presentation by a pressure sense presentation unit and output of force sense presentation by a force sense presentation unit at different timings for at least a part of a body.

### BRIEF DESCRIPTION OF DRAWINGS

FIG. 1 is a diagram illustrating an overview of a perception presentation device according to an embodiment of the present disclosure.

FIG. 2 is a diagram illustrating an overview of perception presentation control according to the present embodiment.

FIG. 3 is a block diagram illustrating an example of a configuration of a perception presentation system according to the present embodiment.

FIG. 4 is a diagram illustrating an example of an actuator that presents a pressure sense according to the present embodiment.

FIG. 5 is a transition diagram illustrating perception presentation control according to contact between a virtual object and a finger according to first perception presentation control example of the present embodiment.

FIG. 6 is a graph illustrating an example of output of pressure sense presentation and force sense presentation by the first perception presentation control example of the present embodiment.

FIG. 7 is a flowchart of operation processing according to the first perception presentation control example of the present embodiment.

FIG. 8 is a diagram illustrating a modification of the first perception presentation control example of the present embodiment.

FIG. 9 is a graph illustrating an example of output of pressure sense presentation and force sense presentation in a hard virtual object according to a second perception presentation control example of the present embodiment.

FIG. 10 is a graph illustrating another example of the output of pressure sense presentation and force sense presentation in a hard virtual object according to the second perception presentation control example of the present embodiment.

FIG. 11 is a diagram illustrating pressure sense presentation and force sense presentation in a soft virtual object according to the second perception presentation control example of the present embodiment.

FIG. 12 is a diagram illustrating control of pressure sense presentation and force sense presentation in a case where a virtual object 50 is grasped according to a third perception presentation control example of the present embodiment.

FIG. 13 is a graph illustrating an example of output of pressure sense presentation and force sense presentation in a case where a virtual object is nipped with fingers according to the third perception presentation control example of the present embodiment.

FIG. 14 is a diagram illustrating expression of a change in feel when a virtual object is operated while being nipped with fingers by fourth perception presentation control of the present embodiment.

FIG. 15 is a diagram illustrating perception presentation control depending on the resolution of an actuator according to a seventh perception presentation control example of the present embodiment.

FIG. 16 is a diagram illustrating perception presentation control in the case of a bumpy shape according to an eighth perception presentation control example of the present embodiment.

FIG. 17 is a diagram illustrating a plurality of pressure sense presentation actuators in a ninth perception presentation control example of the present embodiment.

FIG. 18 is a diagram illustrating control by the plurality of pressure sense presentation actuators in the ninth perception presentation control example of the present embodiment.

### MODE FOR CARRYING OUT THE INVENTION

A preferred embodiment of the present disclosure is hereinafter described in detail with reference to the accompanying drawings. Note that, in the present specification and the drawings, components having substantially the same functional configuration are denoted by the same reference sign, and redundant descriptions are omitted.

Furthermore, descriptions will be given in the following order.
1. Overview of perception presentation device according to one embodiment of present disclosure
2. Configuration of perception presentation system
3. Perception presentation control example
3-1. First perception presentation control example
3-2. Second perception presentation control example
3-3. Third perception presentation control example
3-4. Fourth perception presentation control example
3-5. Fifth perception presentation control example
3-6. Sixth perception presentation control example
3-7. Seventh perception presentation control example
3-8. Eighth perception presentation control example
3-9. Ninth perception presentation control example
3-10. Others
4. Supplement

### 1. Overview of Perception Presentation Device According to One Embodiment of Present Disclosure

The present disclosure provides a perception presentation device capable of more effectively performing perception presentation on at least one part of a user's body according to contact with a virtual object. As a result, at the time of an XR experience such as virtual reality (VR) and augmented reality (AR), it is possible to present a feeling as if the user actually touches the virtual object to the user (operator). More specifically, as the perception presentation, pressure sense presentation that gives a tactile stimulus to a virtual object by pressing and force sense presentation that gives a sense of drag received from the virtual object by transmission of a reaction force are performed.

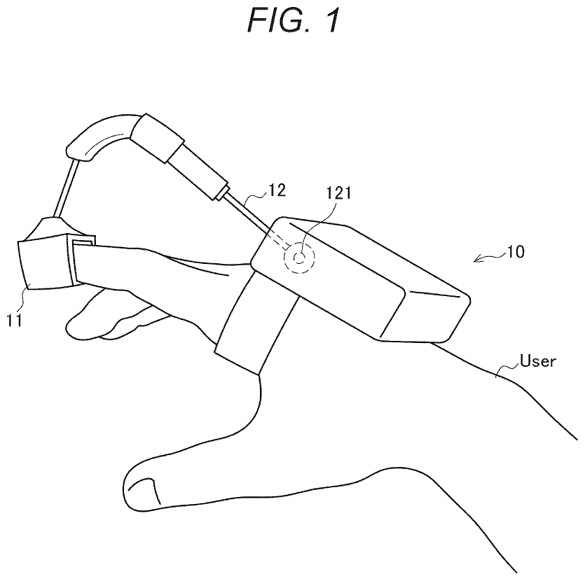

FIG. 1 is a diagram illustrating an overview of a perception presentation device 10 according to an embodiment of the present disclosure. As illustrated in FIG. 1, the perception presentation device 10 according to the present embodiment is formed by an exoskeletal device worn on the hand of a user. The perception presentation device 10 includes a cap-type pressure sense presentation unit 11 attached to the fingertip, and a force sense presentation unit 12 connected to the pressure sense presentation unit 11 and pulling the fingertip. Note that in the present embodiment, a case where the perception presentation is performed on the fingertip of the index finger of the user will be described as an example of “at least one part of a user's body” of the object to which the perception presentation is performed. However, the present disclosure is not limited thereto, and other fingers such as the thumb or the middle finger may be used, or a plurality of fingers may be used. Furthermore, all the fingers of the right hand or the left hand may be used, or all the fingers of both hands may be used. Furthermore, here, a configuration for performing perception presentation to the fingertip will be described as an example, but the present disclosure is not limited thereto, and may be a configuration for performing perception presentation to the palm of the hand. The perception presentation device 10 is not limited to the shape (exoskeletal device) worn on the hand, and may be provided in a controller or the like held by the user and may perform pressure sense presentation and force sense presentation on the palm or fingers of the user. Furthermore, the object of perception presentation is not limited to the finger or the hand, and may be the arm, the shoulder, the abdomen, the foot, or the like.

The pressure sense presentation unit 11 illustrated in FIG. 1 applies a tactile stimulus to the fingertip by pressing the finger pad with a pressing unit (actuator that presents a pressure sense) provided inside. The actuator that presents a pressure sense can be implemented by a balloon that is inflated by sending air, a solenoid, a linear motion motor, a servomotor, or the like that is driven in the direction of the finger pad.

The output of a pressure sense according to the present embodiment may be an expansion amount of the balloon or a pressure of the balloon. Note that the actuator that presents the pressure sense is not limited thereto.

Furthermore, in the force sense presentation unit 12 illustrated in FIG. 1, a support unit with the back of the hand as a base point is connected to the pressure sense presentation unit 11, and the force sense is presented to the fingertip. Specifically, the support unit rotates (in the direction of the back of the hand) about a rotation shaft 121 by a motor or the like provided in a housing attached to the back of the hand, thereby transmitting a reaction force to the fingertip.

The output of a force sense according to the present embodiment may be a torque amount (or a current amount) or a movement amount of the fingertip. Force sense presentation is performed when the user touches or grasps a virtual object (with the finger pad), and can give the user a perception that feels like a reaction force from the virtual object. The structure of the force sense presentation unit 12 illustrated in FIG. 1 is not limited thereto.

Note that the appearance of the perception presentation device 10 illustrated in FIG. 1 is not limited thereto. Furthermore, a method of attaching the perception presentation device 10 to the hand is not particularly limited.

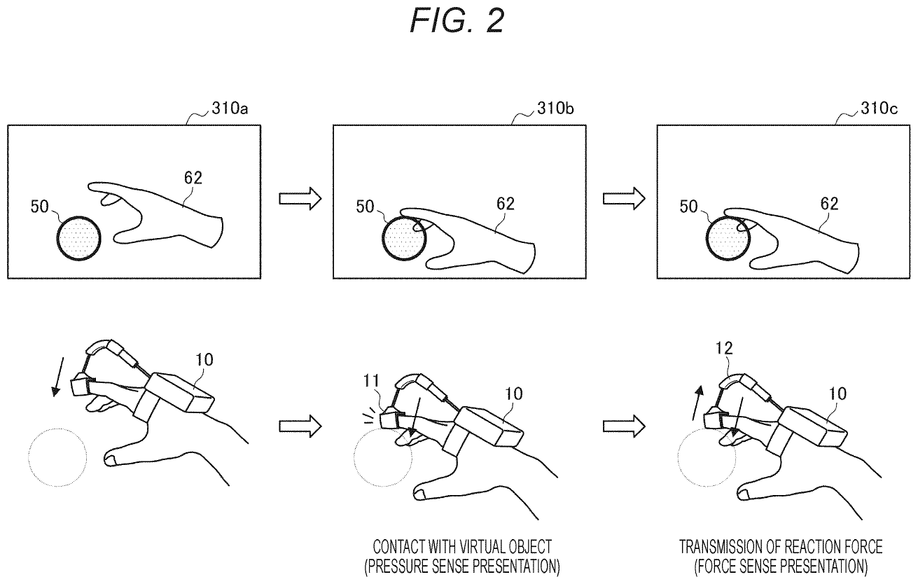

FIG. 2 is a diagram illustrating an overview of perception presentation control according to the present embodiment. In the perception presentation control according to the present embodiment, pressure sense presentation control and force sense presentation control

Can be performed according to contact with a virtual object 50. Contact with the virtual object 50 is virtual contact between the virtual object 50 and the body that is a perception presentation target. More specifically, virtual contact is assumed to be a case where a region of the virtual object 50 and a position of one part of the body (here, the position of the fingertip) that is a perception presentation target overlap (come into contact with a boundary line of the virtual object 50) or approach within a predetermined distance. The position of the body (which may be a three-dimensional position) can be recognized by a camera or the like.

For example, in the case of AR, the virtual object 50 is superimposed and displayed in real space on a transparent display (or a video see-through display), and virtual contact between the display position of the virtual object 50 and the user's fingertip in real space is recognized. Furthermore, in the case of VR, a video of a virtual space is displayed on a head mounted display (HMD) or the like that covers the user's field of view, and the virtual object 50 and a virtual operation body corresponding to the movement of the user's hand or the operation of a controller are displayed in the virtual space. Here, contact between the virtual object 50 and the virtual operation body is recognized as the “virtual contact between the virtual object 50 and the body that is a perception presentation target”. A virtual operation body may be an image (2D or 3D CG, or the like) imitating a hand, or may be an operation object such as an inspection tool or a tool. Using the VR technology, remote treatment, remote work, operation of medical/industrial robots, training, and the like can be performed, and various virtual operation bodies are assumed.

The example illustrated in FIG. 2 assumes a case where the user wears an HMD and views a VR video. In an image 310 (310a to 310c) displayed on the HMD, the virtual object 50 and a virtual hand 62 (image), which is an example of a virtual operation body, are displayed.

The display of the virtual hand 62 can be controlled according to the position and inclination of the user's finger. When the user regards the virtual hand 62 as his/her hand and moves the virtual hand 62 so as to grip or stroke the virtual object 50 in the virtual space, the perception presentation device 10 performs perception presentation on the user's hand according to the contact between the virtual hand 62 and the virtual object 50, so that it is possible to obtain a feeling as if the user actually touches the virtual object 50.

Here, if the pressure sense presentation to the fingertip and the force sense presentation to the fingertip are simultaneously performed, the feel of pressure sense to the fingertip is masked by the force sense presentation, and the pressure sense may be difficult to recognize. That is, when a force is applied to the finger pad by the pressure sense presentation, the finger pad is compressed, so that the pressure presentation by the pressure sense presentation unit 11 is difficult to perceive.

Therefore, in the present embodiment, it is possible to more effectively perform perception presentation by performing output of pressure sense presentation and output of force sense presentation at different timings.

For example, in the example illustrated in FIG. 2, first, as illustrated on the left of FIG. 2, the user moves the hand in real space to touch the virtual object 50. At this time, in the user's field of view, the virtual hand 62 is approaching the virtual object 50 as illustrated in an image 310a. Next, as illustrated at the center in FIG. 2, at the timing when the hand (virtual hand 62) comes into contact with the virtual object 50, the pressure sense presentation unit 11 performs pressure sense presentation on the finger pad to cause a tactile sensation of the virtual object 50 to be perceived. Next, when the fingertip sinks into the virtual object 50 (in the user's field of view, the movement of the virtual hand 62 stops at the point of contact with the virtual object 50, but the finger in real space is not fixed and thus can be further pushed in), as illustrated on the right in FIG. 2, the reaction force from the virtual object 50 is applied by pulling up the fingertip by the force sense presentation unit 12 with the back of the hand as a base point. As described above, by performing output of pressure sense presentation and output of force sense presentation at different timings, it is possible to more effectively perform perception presentation without being masked by one perception.

### 2. Configuration of Perception Presentation System

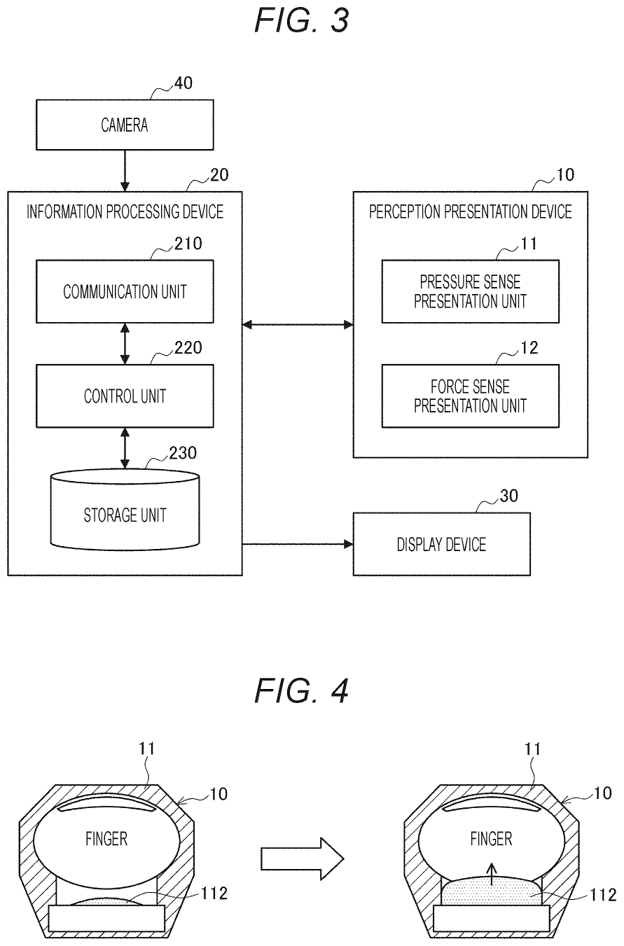

Next, a configuration of a perception presentation system according to the present embodiment will be described with reference to FIG. 3. FIG. 3 is a block diagram illustrating an example of a configuration of the perception presentation system according to the present embodiment. As illustrated in FIG. 3, the perception presentation system according to the present embodiment includes the perception presentation device 10, an information processing device 20, a display device 30, and a camera 40.

### 2-1. Perception Presentation Device 10

The perception presentation device 10 is an exoskeletal device worn on the user's hand as described with reference to FIG. 1. The perception presentation device 10 includes the pressure sense presentation unit 11 and the force sense presentation unit 12, and an actuator (a balloon or the like) that presents a pressure sense or an actuator (a motor or the like) that presents a force sense can be driven according to a control signal from the information processing device 20. The perception presentation device 10 and the information processing device 20 may be connected to communicate with each other in a wired or wireless manner.

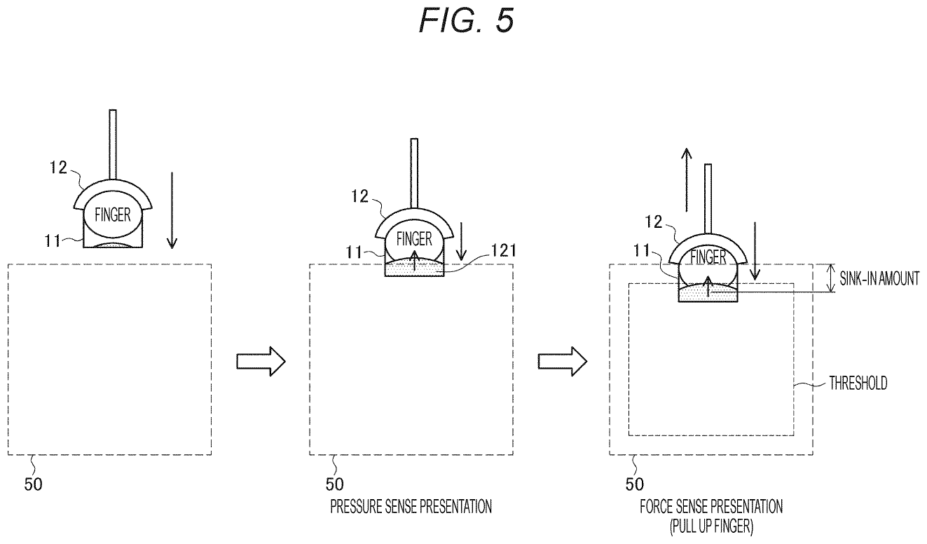

FIG. 4 is a diagram illustrating an example of an actuator that presents a pressure sense. As illustrated in FIG. 4, for example, the pressure sense presentation unit 11 is formed as a cap type attached to the fingertip, and a balloon 112 inflated by air pressure is installed on the finger pad side. The perception presentation device 10 can send air into the balloon 112 through a tube (not illustrated) connected to the balloon 112 to inflate it at any timing. Pressing the finger by the balloon 112 gives the finger a tactile sensation.

Furthermore, each of the pressure sense presentation unit 11 and the force sense presentation unit 12 may be provided with a sensor. Each sensor transmits the detected value to the information processing device 20. For example, a pressure sensor may be provided in the pressure sense presentation unit 11, and may detect an output value (pressure value) of an actuator that presents a pressure sense and transmit the output value to the information processing device 20.

Furthermore, the force sense presentation unit 12 may be provided with an encoder, and may detect a rotation angle of a motor or the like as an output value of an actuator (motor or the like) that presents a force sense and transmit the output value to the information processing device 20. In the information processing device 20, the position and angle of the fingertip (the relative position and angle of the fingertip with respect to the back of the hand) can be calculated from the rotation angle of the motor or the like.

Furthermore, a tracking marker for recognizing a position by the camera 40 installed outside may be attached to the perception presentation device 10. The position of the perception presentation device 10 can be calculated by an outside-in method as an example. Note that the present embodiment is not limited thereto, and the position of the perception presentation device 10 may be calculated by an inside-out method. The perception presentation device 10 may be provided with a camera and various sensors such as a gyro sensor and an acceleration sensor, and the detected value may be transmitted to the information processing device 20 in real time.

### 2-2. Information Processing Device 20

As illustrated in FIG. 3, the information processing device 20 includes a communication unit 210, a control unit 220, and a storage unit 230. For example, the information processing device 20 can be implemented by a smartphone, a tablet terminal, a personal computer (PC), a head mounted display (HMD) mounted on the head, a projector, a television device, a game console, or the like.

The communication unit 210 transmits and receives data to and from an external device in a wired or wireless manner. The communication unit 210 is communicably connected to the perception presentation device 10, the camera 40, and the display device 30 using, for example, a wired/wireless local area network (LAN), Wi-Fi (registered trademark), Bluetooth (registered trademark), a mobile communication network (long term evolution (LTE), a fourth generation mobile communication system (4G), or a fifth generation mobile communication system (5G) ), or the like.

The control unit 220 functions as an arithmetic processing device and a control device, and controls the overall operation in the information processing device 20 according to various programs. The control unit 220 is implemented by, for example, an electronic circuit such as a central processing unit (CPU), a microprocessor, or the like. Furthermore, the control unit 220 may include a read only memory (ROM) that stores programs, computation parameters, and the like to be used, and a random access memory (RAM) that temporarily stores parameters and the like that change appropriately.

The control unit 220 performs control to display the virtual object 50 on the display device 30.

Furthermore, the control unit 220 may perform control to display a video of the virtual space. The virtual object 50 may be included in the video of the virtual space.

The video of the virtual space may be acquired from a server (not illustrated) via the communication unit 210, or may be generated by the control unit 220.

Furthermore, the control unit 220 may perform control to display a virtual hand (image), which is an example of a virtual operation body, on the display device 30 according to the movement of the user's hand or the operation of the controller by the user. The control unit 220 can control the position and angle of the virtual hand and the position and angle of each finger of the virtual hand according to the movement of the user's hand or the operation of the controller by the user. The position of the user's hand can be recognized by, for example, analysis of a captured image captured by the camera 40. The control unit 220 analyzes the captured image acquired from the camera 40 in real time, and calculates, for example, the position of the tracking marker attached to the perception presentation device 10 (for example, the position of the back of the hand) worn on the user's hand. Furthermore, the control unit 220 calculates the position of the user's finger from the rotation angle transmitted from the perception presentation device 10 and detected by a sensor (for example, an encoder) provided in the force sense presentation unit 12. When the support unit of the force sense presentation unit 12 connected to the pressure sense presentation unit 11 placed over the fingertip is not performing force sense presentation by rotation, the support unit does not transmit any force and does not fix the finger, so that the user can freely move the finger.

Note that the above-described method of calculating the positions of the user's hand and fingertip is an example, and the present embodiment is not limited thereto. For example, the tracking marker may also be attached to the fingertip. Furthermore, the captured image may be analyzed to perform object recognition, and the shape of the hand or the perception presentation device 10 may be recognized to calculate the position.

Furthermore, the control unit 220 performs control to present perception to the fingertip according to contact between the virtual object 50 and the fingertip.

More specifically, when the region of the virtual object 50 and the position of the fingertip overlap (when the calculated position of the fingertip comes into contact with the boundary line of the virtual object 50) or come close and are within a certain distance to each other, the control unit 220 causes the perception presentation device 10 to present a pressure sense and a force sense at different timings. As a result, it is possible to make the user perceive the feel of the virtual object 50 more effectively. The control unit 220 transmits a control signal to the perception presentation device 10.

Note that details of presentation control will be described later.

The storage unit 230 is implemented by a read only memory (ROM) that stores programs, computation parameters, and the like used for processing of the control unit 220, and a random access memory (RAM) that temporarily stores parameters and the like that change appropriately.

2-3. Display Device 30 The display device 30 is a device having a function of presenting an image to the user. The display device 30 is communicably connected to the information processing device 20 in a wired or wireless manner, receives image data from the information processing device 20, and displays the image data. The display device 30 may be implemented by, for example, a transmissive or non-transmissive head mounted display (HMD), a projector, a television device, or the like. As an HMD having a non-transmissive display unit, a device that is formed with a configuration covering the entire field of view of the user and provides a sense of immersion in the virtual space is assumed. The display unit of such an HMD includes a left-eye display and a right-eye display, and the user can stereoscopically view the video from the user's viewpoint in the virtual space. Furthermore, examples of the HMD having a non-transmissive display unit include an eyewear device having a so-called AR display function of superimposing and displaying a virtual object in real space.

Furthermore, the HMD may be a device capable of arbitrarily switching the display unit between non-transmissive and transmissive.

Note that the display device 30 according to the present embodiment is not limited to a device configured separately from the information processing device 20, and may be a device integrated with the information processing device 20.

### 2-4. Camera 40

The camera 40 images the perception presentation device 10 and transmits the captured image to the information processing device 20. The camera 40 is communicably connected to the information processing device 20 in a wired or wireless manner, and can transmit a captured image to the information processing device 20 in real time. Furthermore, the camera 40 may have a tracking function of tracking the position of the perception presentation device 10. Note that the tracking function may be implemented by the control unit 220 of the information processing device 20. The camera 40 may be installed around the user. The camera 40 may be an RGB camera or an infrared camera. Furthermore, the camera 40 may be provided with a depth sensor (distance sensor).

Note that, here, a case where the position of the perception presentation device 10 is calculated by an outside-in method is taken as an example, but the present embodiment is not limited thereto, and the position of the perception presentation device 10 may be calculated by an inside-out method. For example, the camera 40 may be provided in the perception presentation device 10, and the self-position can be estimated by imaging the outside world.

The configuration of the perception presentation system according to the present embodiment has been described above. Note that the configuration of the perception presentation system according to the present disclosure is not limited to the example illustrated in FIG. 3. For example, the information processing device 20 may be implemented by a plurality of devices, or a configuration may be adopted in which at least some of the functions of the control unit 220 of the information processing device 20 are provided in the perception presentation device 10. Furthermore, the camera 40 is provided as means for detecting the position of the perception presentation device 10, but the present disclosure is not limited thereto.

### 3. Perception Presentation Control Example

Next, a perception presentation control example according to the present embodiment will be described in detail with reference to the drawings.

### 3-1. First Perception Presentation Control Example

First, a first perception presentation control example will be described with reference to FIGS. 5 to 7. FIG. 5 is a transition diagram illustrating perception presentation control according to contact between the virtual object 50 and a finger. As illustrated on the left in FIG. 5 and at the center in FIG. 5, from the moment at which the virtual object 50 comes into contact with the finger until the finger sinks into the virtual object 50 to some extent, the pressure sense presentation unit 11 presents a pressure sense to the finger pad and produces a feeling of contact with the virtual object 50. The control unit 220 calculates the position of the fingertip (finger pad) and starts the pressure sense presentation from the moment of contact with the boundary of the virtual object 50. In the case of VR, the position of the fingertip (finger pad) in real space corresponds to the position of the fingertip (finger pad) of the corresponding virtual hand. The control unit 220 can control the output of pressure sense presentation according to the sink-in amount of the finger. For example, the output of pressure sense presentation may be controlled such that the intensity of the pressure sense (pressure value) increases as the sink-in amount increases. For example, in a case where the actuator that presents the pressure sense is a balloon, the air pressure increases as the sink-in amount increases, and the balloon presses the finger pad. Furthermore, in the case of a linear motion actuator, as the sink-in amount is larger, the linear motion actuator (solenoid or the like) operates in the direction of the finger pad, and the linear motion actuator presses the finger pad.

Additionally, in any case, the pressing can be fixed with a predetermined pressure value defined as the maximum output value.

Since the virtual object 50 does not exist in real space and the user's hand and arm are not fixed, the user can push the hand (finger) into the region of the virtual object 50. However, since the virtual object 50 and the hand (virtual hand) are in contact with each other in the user's field of view, if the hand (finger) can be pushed forward into the region of the virtual object 50 without any resistance, it becomes perceptually unnatural.

Therefore, in the present embodiment, as illustrated on the right in FIG. 5, the force sense presentation unit 12 performs force sense presentation (specifically, an operation of pulling the finger upward) for transmitting a reaction force to the finger, so that it is possible to present a force sense that feels like a reaction force from the virtual object 50. Furthermore, the force sense presentation is performed after the pressure sense presentation so as not to mask the pressure sense by the force sense.

As described above, in the first perception presentation control example, by performing force sense presentation after pressure sense presentation, it is possible to make the user perceive different senses without masking the contact feeling due to the pressure sense presentation with the force sense presentation. There are various conceivable timings at which force sense presentation is performed. After pressure sense presentation, the control unit 220 can perform force sense presentation in a case where a predetermined condition is satisfied.

For example, the control unit 220 may perform force sense presentation in a case where the sink-in amount of a finger into the virtual object 50 (position of the finger pad) exceeds a threshold. A sink-in amount is assumed to be an amount by which the position of the fingertip (finger pad) enters the virtual object 50 (orthogonal distance to the boundary line). As illustrated on the right in FIG. 5, for example, a distance threshold may be provided in the virtual object 50, and in a case where the finger sinks into this position, a reaction force may be applied by force sense presentation. Even if the user tries to push the finger further into the virtual object 50 (push downward), the finger is pulled back (upward) by the force sense presentation unit 12, and a sense of resistance against the push can be presented.

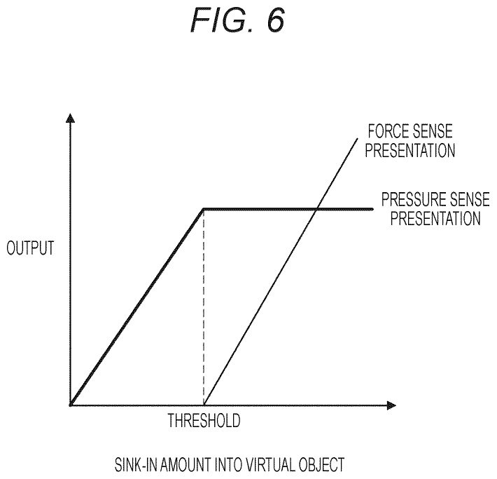

FIG. 6 is a graph illustrating an example of output of pressure sense presentation and force sense presentation by the first perception presentation control example. As illustrated in FIG. 6, output from the pressure sense presentation unit 11 (for example, air is sent into the balloon 112) is first started according to the contact, and output from the force sense presentation unit 12 (for example, rotation of a motor) is started when the sink-in amount of the finger into the virtual object 50 exceeds the threshold. At this time, the output of pressure sense presentation by the pressure sense presentation unit 11 is fixed. That is, the output of force sense presentation is started after maintaining the state of the pressure sense presentation at the time point when a predetermined condition is satisfied. For example, the control unit 220 maintains a state in which the balloon 112 is inflated to some extent (a state in which a pressure sense is presented). Then, the control unit 220 starts output by the force sense presentation unit 12 (for example, rotation by the motor) and presents a force sense (reaction force) to the fingertip. The control unit 220 increases the magnitude of the output by the force sense presentation unit 12 according to the sink-in amount, thereby performing control to lift the finger that is pressed in further.

Note that the predetermined condition for starting the force sense presentation is not limited to the condition regarding the sink-in amount. For example, a case where the elapsed time from the start of the output of pressure sense presentation exceeds a threshold may be used as the condition, or a case where the pressure value in pressure sense presentation exceeds a threshold may be used as the condition. Furthermore, satisfying a plurality of the conditions described above may be used as the condition.

Furthermore, the control unit 220 may set the threshold in each condition appropriately according to the size of the virtual object 50. For example, the larger the size of the virtual object 50, the larger the threshold of the sink-in amount may be.

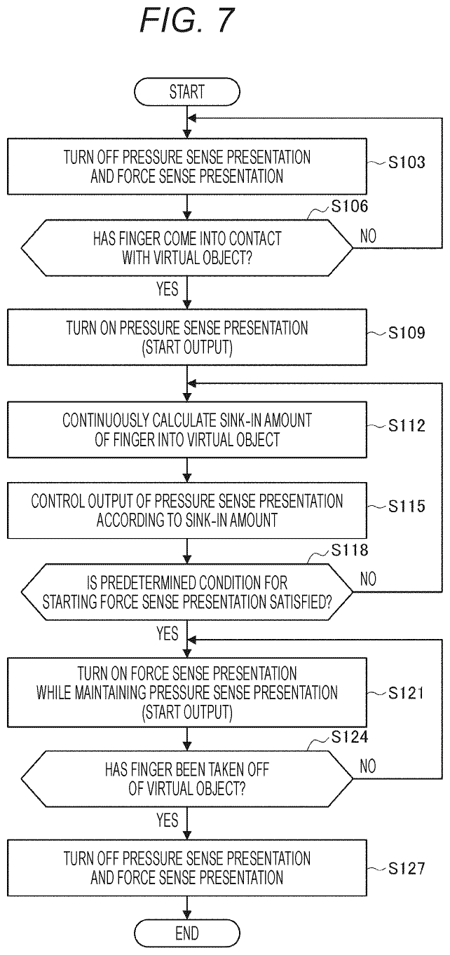

FIG. 7 is a flowchart of operation processing according to the first perception presentation control example. As illustrated in FIG. 7, first, when the finger is moved freely in the virtual space (without touching the virtual object 50), the outputs of pressure sense presentation and force sense presentation are turned off (step S103).

Next, in a case where the finger comes into contact with the virtual object 50 (step S106/Yes), the control unit 220 performs control to turn on the pressure sense presentation (step S109). Specifically, the pressure sense presentation unit 11 starts the output of pressure sense presentation. For example, air is sent into the balloon 112.

Next, the control unit 220 continuously calculates the sink-in amount of the finger (the finger of the virtual hand) into the virtual object 50 (step S112).

For example, the control unit 220 can calculate the position of the finger from the position of the back of the hand obtained by analysis of a captured image acquired in real time from the camera 40 and the value of the sensor of the force sense presentation unit 12 acquired in real time from the perception presentation device 10 (the rotation angle of the support unit rotating with the back of the hand as a base point), reflect the position of the finger in the virtual space, and calculate the sink-in amount of the finger (the finger of the virtual hand) into the virtual object 50.

Note that various parameters (for example, the length of the user's finger) used for position detection can be prepared in advance.

Next, the control unit 220 controls the output of pressure sense presentation according to the sink-in amount of the finger (step S115). For example, the control unit 220 may control the output of pressure sense presentation (for example, adjust the amount of air sent into the balloon 112) such that the intensity of the pressure sense (pressure value) increases as the sink-in amount of the finger increases.

Next, it is determined whether or not a predetermined condition for starting force sense presentation is satisfied (step S118). An example of a predetermined condition is a case where the sink-in amount exceeds a threshold, for example.

Next, in a case where the predetermined condition is satisfied (step S118/Yes), the control unit 220 performs control to turn on force sense presentation in a state where pressure sense presentation is maintained (for example, the pressure value is fixed without discharging air from the balloon 112) (step S121).

Specifically, the force sense presentation unit 12 starts the output of force sense presentation. For example, the motor is driven to rotate the support unit. The force sense presentation by the force sense presentation unit 12 can be controlled according to the sink-in amount until the finger is taken off of the virtual object 50.

Then, in a case where the finger is taken off of the virtual object 50 (step S124/Yes), control is performed to turn off the pressure sense presentation and the force sense presentation (step S127). Turning off the pressure sense presentation is assumed to be, for example, performing control to discharge air from the balloon 112. Furthermore, turning off the force sense presentation is assumed to be, for example, freeing the rotation of the support unit.

An example of the perception presentation control according to the present embodiment has been described above. Note that, while the predetermined condition is not satisfied, only the pressure sense presentation is turned on, and the force sense presentation remains turned off. It is also assumed that the finger is taken off of the virtual object 50 without satisfying the predetermined condition. In this case, the pressure sense presentation is turned off without turning on the force sense presentation.

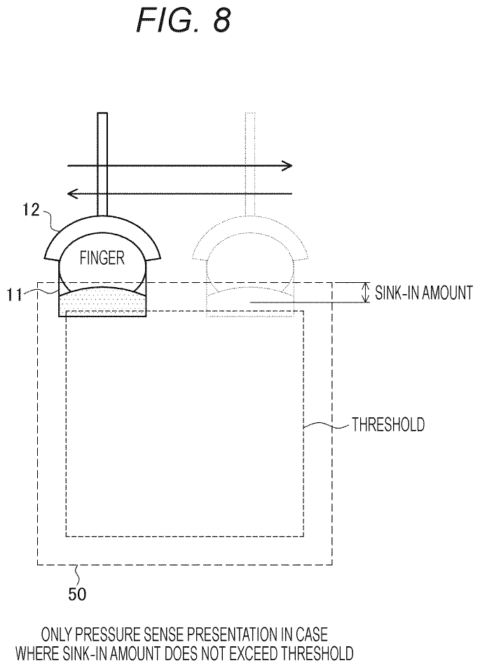

For example, as illustrated in FIG. 8, in a case where the finger is moving in a state where the sink-in amount does not exceed the threshold (for example, in a case where the finger is stroking the surface of the virtual object 50), only the pressure sense presentation by the pressure sense presentation unit 11 is turned on to present the contact feeling, and the force sense presentation by the force sense presentation unit 12 remains turned off.

### 3-2. Second Perception Presentation Control Example

Next, a second perception presentation control example will be described. The control unit 220 may control pressure sense presentation and force sense presentation according to a physical property parameter such as hardness/softness of the virtual object 50. With this configuration, it is possible to more effectively make the user perceive the hardness/softness of the virtual object 50.

### Case Where Virtual Object is Hard

In a case where the virtual object 50 is set to have a hard physical property, force sense presentation is more important to express hardness, and thus the output of the force sense may be superimposed and output when the output of the pressure sense is increased (when the pressure is increased).

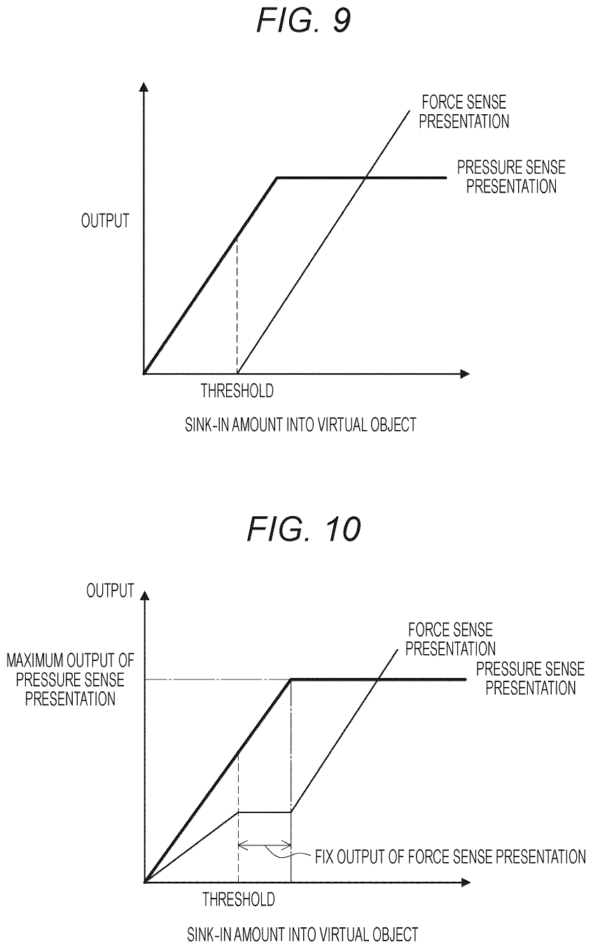

For example, the control unit 220 may set a smaller threshold than in the case described with reference to FIG. 6, and perform control to start force sense presentation while the pressure sense presentation unit 11 is increasing the output of the pressure sense. FIG. 9 is a graph illustrating an example of output of pressure sense presentation and force sense presentation in a hard virtual object according to the second perception presentation control example of the present embodiment. The output of the pressure sense can be performed up to the maximum output according to the sink-in amount.

Furthermore, at the moment when the finger comes into contact with the virtual object 50, the control unit 220 may start the presentation of the force sense (control of the motor) by the force sense presentation unit 12 together with pressure sense presentation. Note, however, that since it is difficult to perceive the pressure sense if the force sense is presented at the same time as the pressure sense, force sense presentation control may be performed to such an extent that the position of the finger (rotation angle, position of motor) is fixed until the sink-in amount reaches a certain amount. FIG. 10 is a graph illustrating another example of the output of pressure sense presentation and force sense presentation in a hard virtual object according to the second perception presentation control example of the present embodiment. As illustrated in FIG. 10, the output of force sense presentation may be started together with the start of the output of pressure sense presentation, and the force sense presentation by the force sense presentation unit 12 may be temporarily fixed from a certain sink-in amount until the pressure sense presentation reaches the maximum output (maximum value of pressure). Fixing (maintaining) the force sense presentation is assumed to be, for example, fixing the position of the motor, that is, maintaining the rotation angle of the support unit at a predetermined angle (predetermined finger position). Note that in a case where the finger is pushed in with a force stronger than the presented force sense or in a case where the hand or the arm is moved, the finger sinks into the virtual object 50 further, and a contact feeling can be presented by pressure sense presentation according to the sink-in amount. Even in a case where the surface of the hard virtual object 50 is stroked, the contact feeling can be expressed by pressure sense presentation, and the hardness can be expressed by force sense presentation.

Then, in a case where the pressure sense presentation reaches the maximum output (maximum value of pressure), the control unit 220 resumes the output of force sense presentation as illustrated in FIG. 10. That is, force sense presentation is performed to increase the rotation angle of the support unit by driving the motor, and a reaction force stronger than the degree of fixing the position of the finger can be transmitted to the fingertip.

### Case of Where Virtual Object is Soft

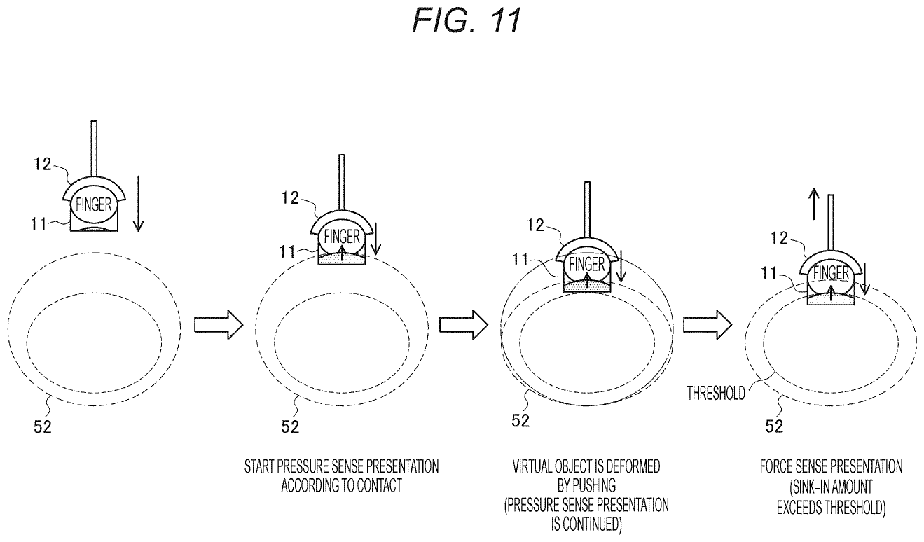

On the other hand, in a case where the virtual object 50 is set to have a soft physical property, in order to express softness, it is possible to perform control to delay the timing of force sense presentation (the timing of transmitting the reaction force) more than usual. The “control to delay more than usual” can be achieved by setting a threshold larger than the threshold in the example with reference to FIGS. 5 and 6 or the threshold in the case of the hard virtual object described with reference to FIGS. 9 and 10. FIG. 11 is a diagram illustrating pressure sense presentation and force sense presentation in a soft virtual object 52 according to the second perception presentation control example.

As illustrated in FIG. 11, when the finger comes into contact with the soft virtual object 52, first, the pressure sense presentation unit 11 starts pressure sense presentation. Next, display control is performed such that the virtual object 52 is deformed according to a push (sink-in amount) by the finger. During this time, it is possible to perform just the pressure sense presentation (the pressure is increased according to the sink-in amount).

Then, as illustrated on the right in FIG. 11, in a case where the sink-in amount exceeds the threshold, presentation of the force sense by the force sense presentation unit 12 is started, and the reaction force from the virtual object 52 is transmitted. By increasing the threshold (for example, the orthogonal distance from the boundary line of the virtual object 52), the timing of the force sense presentation start can be delayed, and the amount by which the virtual object 52 is pushed can be increased. As a result, the softness of the virtual object 52 can be expressed.

### 3-3. Third Perception Presentation Control Example

Next, as a third perception presentation control example, control of pressure sense presentation and force sense presentation in a case where the virtual object 50 is grasped (nipped with fingers) will be described.

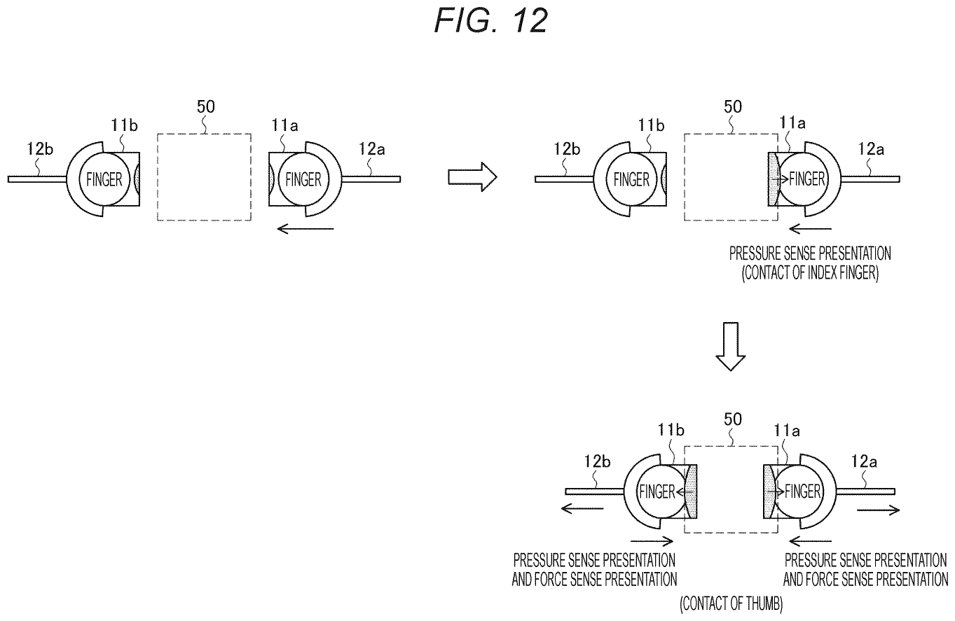

FIG. 12 is a diagram illustrating control of pressure sense presentation and force sense presentation in a case where the virtual object 50 is grasped according to the third perception presentation control example. As illustrated in the upper part of FIG. 12, first, in a case where one finger (for example, the index finger) first comes into contact with the virtual object 50, the basic control as described with reference to FIG. 5, that is, the pressure presentation is started by a pressure sense presentation unit 11a from the moment of contact, and the output of pressure presentation is increased according to the sink-in amount.

Next, as illustrated in the lower part of FIG. 12, in a case where the other finger (for example, the thumb) nips the virtual object 50 from the side facing the one finger, the control unit 220 simultaneously starts pressure sense presentation by a pressure sense presentation unit 11b and force sense presentation by a force sense presentation unit 12b with respect to the other finger, and also starts force sense presentation by a force sense presentation unit 12a with respect to the one finger. In a case where an object is nipped with two fingers, it is natural that a reaction force is generated in both fingers. Therefore, a pressure sense and a force sense are presented simultaneously with the contact of the second finger.

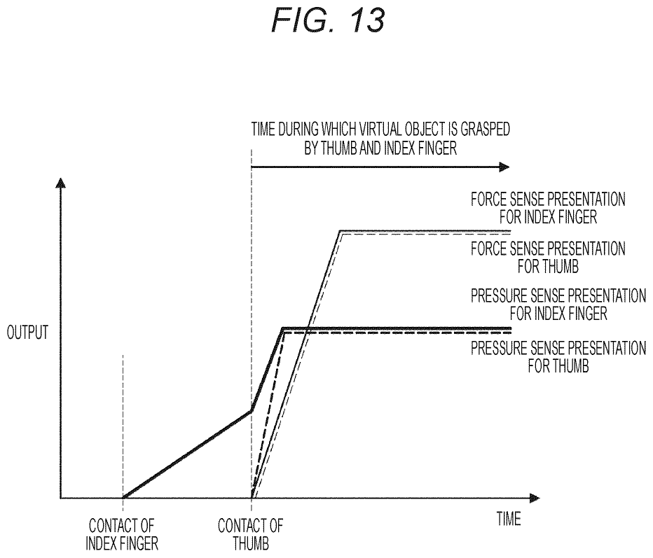

FIG. 13 is a graph illustrating an example of output of pressure sense presentation and force sense presentation in a case where a virtual object is nipped with fingers according to the third perception presentation control example. As illustrated in FIG. 13, for example, when the index finger comes into contact with the virtual object 50, pressure sense presentation to the index finger is started. When the thumb comes into contact next, pressure sense presentation and force sense presentation to the thumb are started, and at the same time, force sense presentation to the index finger is also started. Furthermore, when the force sense presentation is started by the contact of the thumb, control for raising the pressure sense presentation performed on the index finger to the maximum output (control for raising the air pressure to the maximum value) may be performed.

Note that in a case where both fingers come into contact with the virtual object 50 at the same time, pressure sense presentation and force sense presentation may be simultaneously or sequentially performed on both fingers.

Furthermore, in the case of nipping the virtual object 50, too, the timing of performing force sense presentation may be controlled according to the physical property parameter of the hardness/softness of the virtual object 50, similarly to the second perception presentation control. For example, even in a case where the virtual object 50 is nipped with both fingers, it is possible to allow pushing of the virtual object 50 and express the softness of the virtual object 50 by delaying the timing of performing force sense presentation.

### 3-4. Fourth Perception Presentation Control Example

Next, as a fourth perception presentation control example, expression of a change in feel in a case where a virtual object is operated while being nipped with fingers will be described. For example, in a case of operating a dial type switch, when the dial is turned while being pinched, the feel may change to a click.

Furthermore, the feel may also change when a key inserted into a key hole is turned. The control unit 220 can express such a change in feel by control of pressure sense presentation, for example.

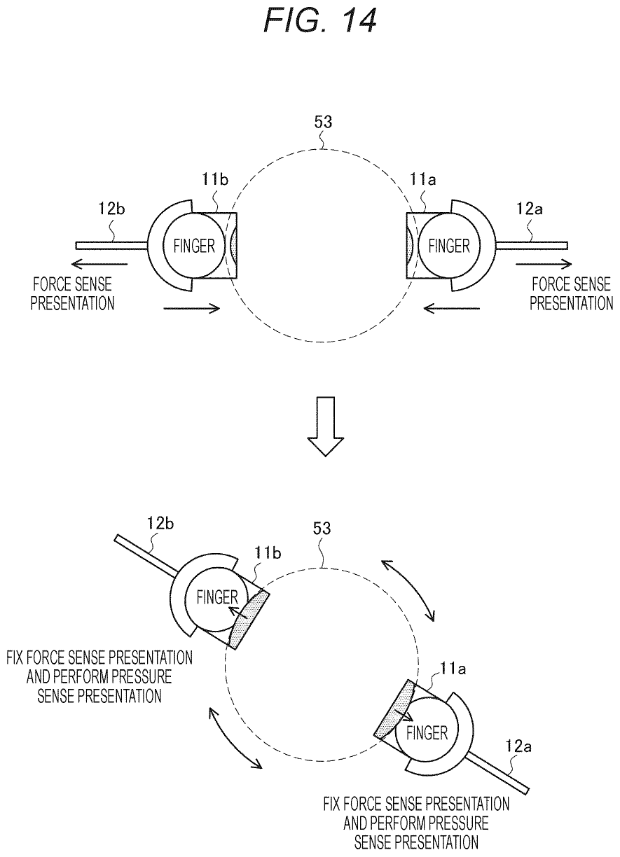

FIG. 14 is a diagram illustrating expression of a change in feel when a virtual object 53 is operated while being nipped with fingers by the fourth perception presentation control. For example, in a case where the virtual object 53 is a dial type switch, when the user nips (touches) the virtual object 53 with fingers as illustrated in the upper part of FIG. 4, the control unit 220 first outputs only the force sense presentation to both fingers to cause the sense of pinching the virtual object 53 to be perceived.

Next, as illustrated in the lower part of FIG. 4, in a case where the user performs an operation of turning the virtual object 53 while pinching the virtual object, the control unit 220 causes the pressure sense presentation unit 11a and the pressure sense presentation unit 11b to simultaneously perform pressure sense presentation to each finger and cause each finger to perceive a change in feel. At this time, since the shape itself of the virtual object 53 does not change, the force sense presentation by the force sense presentation unit 12a and the force sense presentation unit 12b is fixed (that is, force sense presentation to the extent of maintaining the position of the finger is performed.

Specifically, the angle of the support unit (the position of the motor) is fixed). For example, the control unit 220 can present an operation feeling such as clicking of the dial type switch by repeating instantaneous inflation of the balloon 112. Note that, in a case where the change in the feel is large, the output of the force sense may be increased (for example, the driving of the motor is resumed to increase the output) to express the change in the feel more clearly.

Furthermore, in a situation where the pressure sense and the force sense transmitted from the virtual object 53 continuously change, the control unit 220 can also express a change in feel (rattling, crunching, or the like) by simultaneously turning ON/OFF the pressure sense presentation and the force sense presentation.

The control unit 220 may appropriately select a control method of force sense presentation or pressure sense presentation according to a feel parameter (added to the virtual object) to be expressed.

### 3-5. Fifth Perception Presentation Control Example

Next, as a fifth perception presentation control example, control of pressure sense presentation and force sense presentation according to the movement of a virtual object will be described. For example, for a static virtual object, the basic control method (pressure sense presentation is performed according to the contact, and then force sense presentation is performed) as described above with reference to FIG. 5 is performed. On the other hand, for a moving virtual object, since the sense of stopping the movement by pressing the object with a finger can be expressed more clearly with force sense presentation, the control unit 220 may be configured to perform only the force sense presentation according to the contact and not perform the pressure sense presentation. Note that there are cases where it is preferable to perform a delicate expression with only the pressure sense presentation, such as a fine change in the movement when a virtual object moving little by little is pressed. The control unit 220 can perform more preferable perception presentation control according to movement information of the virtual object.

### 3-6. Sixth Perception Presentation Control Example

Next, as a sixth perception presentation control example, control of pressure sense presentation and force sense presentation in a case where the texture of a virtual object is important will be described. In a case where the texture of a virtual object is important (may be determined by a parameter added to the virtual object. Also, a case where a texture parameter is added to the virtual object, or the like), the control unit 220 provides a texture (gritty, slippery, irregular, or the like) by pressure sense presentation according to contact. For example, it is possible to make the user perceive the texture by high-speed ON/OFF (0 to 200 Hz or the like) of an actuator that presents the pressure sense.

Furthermore, in order to lengthen the time for pressure sense presentation, the timing of the force sense presentation may be delayed from the normal timing (for example, the threshold in the case described with reference to FIGS. 5 and 6).

### 3-7. Seventh Perception Presentation Control Example

Next, as a seventh perception presentation control example, control according to the resolution of an actuator that presents a pressure sense will be described. The control unit 220 may perform control depending on the resolution of an actuator that presents a pressure sense. For example, in a case where the actuator has a diameter of 10 mm or less, for example, it is possible to express the sharpness of the virtual object by performing only the pressure sense presentation first. Note that the numerical value is an example, and the present disclosure is not limited thereto.

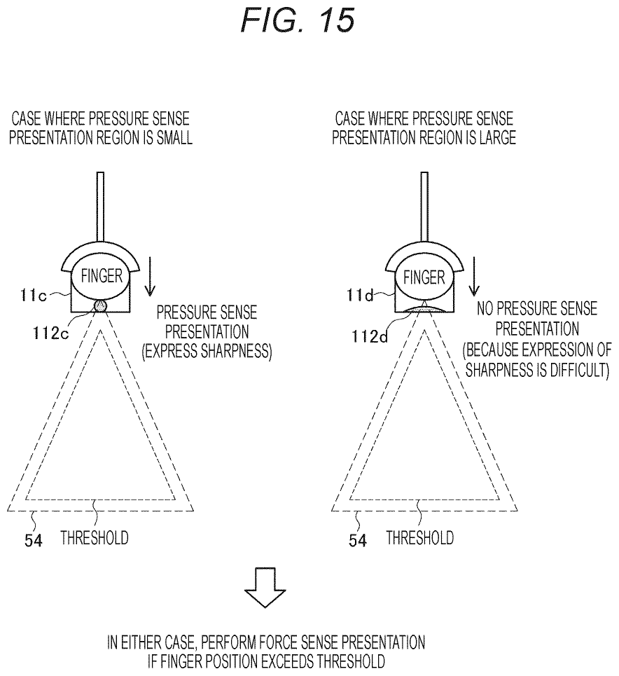

FIG. 15 is a diagram illustrating perception presentation control depending on the resolution of the actuator according to the seventh perception presentation control example. As illustrated on the left in FIG. 7, for example, in a case where the actuator (balloon 112c) has a diameter of 10 mm or less and a virtual object 54 to be brought into contact has a sharp shape, the control unit 220 performs only pressure sense presentation at the time of contact, thereby allowing a sharp sense to be perceived. On the other hand, as illustrated on the right in FIG. 7, for example, in a case where the actuator (balloon 112d) has a diameter of 10 mm or more, it is difficult to cause a sharp sense to be perceived, and thus pressure sense presentation according to contact may be omitted.

In either case, when the position of the finger reaches a threshold, it is possible to make the user perceive the reaction force from the virtual object 54 by force sense presentation.

As described above, the control unit 220 according to the present embodiment can perform pressure sense presentation control depending on the resolution of the actuator at the time of contact with a sharp portion of the virtual object. Note that while contact with a sharp portion has been described herein as an example, the present disclosure is not limited thereto, and pressure sense presentation control depending on the resolution of the actuator can be appropriately performed for contact with a flat portion, a round (curved surface) portion, or the like.

### 3-8. Eighth Perception Presentation Control Example

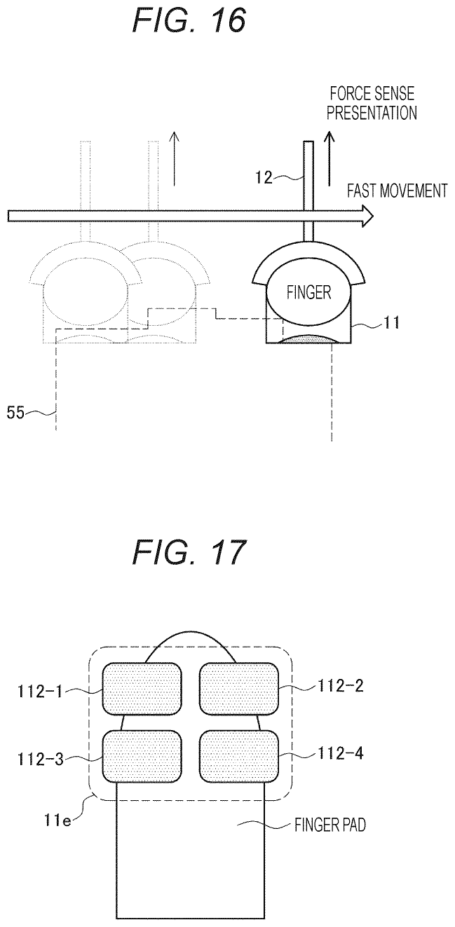

Next, as an eighth perception presentation control example, a case of causing the shape of a virtual object to be perceived by force sense presentation will be described. FIG. 16 is a diagram illustrating perception presentation control in the case of a bumpy shape according to the eighth perception presentation control example. As illustrated in FIG. 16, for example, in a case where the surface of a virtual object 55 having a bumpy shape is touched (traced) in a faster movement (than a predetermined threshold), the control unit 220 can present a tactile sense only by force sense presentation. This is because, in a case where the movement of the touching finger is fast, it is possible to more effectively cause the feel of the shape to be perceived by using force sense presentation rather than pressure sense presentation.

Note that in a case where the movement of the finger is slow, pressure sense presentation may be performed in addition to force sense presentation. This is because, in a case where the movement of the finger is slow, it is easy to perceive a pressure sense presented when the finger is in contact with the surface of a protrusion or a recess having a bumpy shape during perception of a force sense presented when the finger is in contact with the protrusion or the recess.

### 3-9. Ninth Perception Presentation Control Example

Next, as a ninth perception presentation control example, control in a case where a plurality of actuators for presenting a pressure sense is provided will be described.

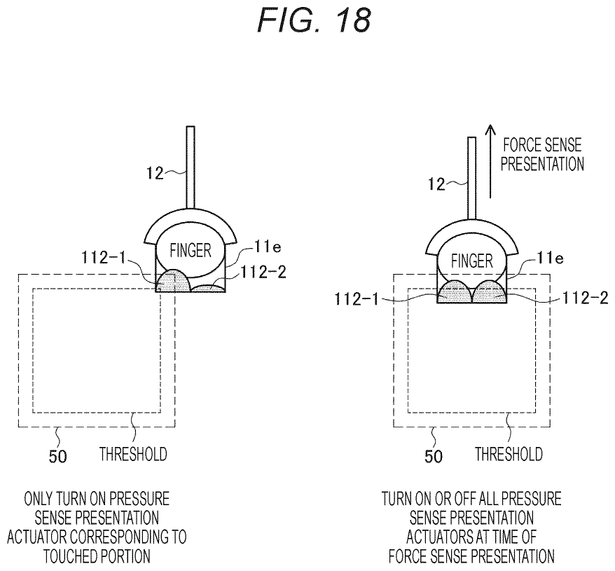

FIG. 17 is a diagram illustrating a plurality of pressure sense presentation actuators in the ninth perception presentation control example. As illustrated in FIG. 17, for example, in a case of being viewed from the finger pad side, a pressure sense presentation unit 11e in which a plurality of pressure sense presentation actuators 112-1 to 112-4 is arranged in 2×2 can also be assumed. In this case, the resolution of the pressure sense presentation can be improved by controlling the pressure sense presentation by the plurality of pressure sense presentation actuators 112-1 to 112-4 according to the positions in contact with the virtual object.

FIG. 18 is a diagram illustrating control of the plurality of pressure sense presentation actuators in the ninth perception presentation control example. As illustrated on the left in FIG. 18, in a case where (the position of) the finger wearing the pressure sense presentation unit 11e comes into contact with the virtual object 50, the control unit 220 activates only the pressure sense presentation actuator 112-1 (for example, a balloon) corresponding to the touched portion. As a result, it is possible to improve the resolution of the pressure sense presentation. That is, the contact feeling can be more delicately presented.

Note that as illustrated on the right in FIG. 18, in a case where the sink-in amount of the finger reaches a threshold, the control unit 220 starts force sense presentation, but at this time, the pressure sense is difficult to perceive due to the presentation of the force sense. Therefore, at the time of the force sense presentation, all of the plurality of pressure sense presentation actuators 112-1 to 112-4 may be turned on or may be turned off.

The number and arrangement of the pressure sense presentation actuators provided in the pressure sense presentation unit 11 are not particularly limited.

Furthermore, in the case where a plurality of pressure sense presentation actuators is provided, the presentation quality of the texture can also be improved. For example, the pressure sense presentation actuators may be alternately turned ON/OFF (each predetermined pair may be used, or random pairs may be used), or all the pressure sense presentation actuators may be simultaneously turned ON/OFF. As a result, temporal resolution can be improved. At this time, by turning off the force sense, difficulty in perceiving the pressure sense can be avoided. Furthermore, in order to secure the time for pressure sense presentation, a threshold (for example, a sink-in amount) in a predetermined condition for the start of the pressure sense presentation may be increased to delay the start of the force sense presentation. As an application example, a case where the virtual object is, for example, a keyboard or a keyboard having many irregularities is assumed.

### 3-10. Others

Since it is difficult to perceive a pressure sense during force sense presentation, the control unit 220 may gradually turn off the output of the pressure sense presentation (for example, gradually discharge air from the balloon 112).

Furthermore, in a case where the finger collides with a virtual object at a high speed (at a predetermined speed or more), the control unit 220 may simultaneously perform pressure sense presentation and force sense presentation.

### 4. Supplement

The preferred embodiment of the present disclosure has been described above in detail with reference to the accompanying drawings, but the present technology is not limited to such examples. It is obvious that those with ordinary skill in the technical field of the present disclosure may conceive various modifications or corrections within the scope of the technical idea recited in claims, and it is naturally understood that they also fall within the technical scope of the present disclosure.

For example, it is also possible to create one or more computer programs for causing hardware such as the CPU, the ROM, and the RAM built in the information processing device 20 and the perception presentation device 10 described above to exhibit the functions of the information processing device 20 and the perception presentation device 10. Furthermore, a computer-readable storage medium that stores the one or more computer programs is also provided.

Furthermore, the effects described in the present specification are merely exemplary or illustrative, and are not restrictive. That is, the technology according to the present disclosure may exert other effects apparent to those skilled in the art from the description of the present specification in addition to or instead of the effects described above.

Note that the present technology may also have the following configurations.
(1)

An information processing device including
a control unit that performs perception presentation control according to contact with a virtual object, in which
the control unit performs, as the perception presentation control, output of pressure sense presentation by a pressure sense presentation unit and output of force sense presentation by a force sense presentation unit at different timings for at least one part of a body.
(2)

The information processing device according to (1) above, in which the contact includes virtual contact between the virtual object and the one part.
(3)

The information processing device according to (2) above, in which the virtual contact is contact between the virtual object displayed on a display unit and a virtual operation body displayed on the display unit and corresponding to the one part.
(4)

The information processing device according to (3) above, in which the virtual operation body includes an image imitating the one part.
(5)

The information processing device according to (2) above, in which the virtual contact includes contact between the virtual object superimposed and displayed in real space and the one part.
(6)

The information processing device according to any one of (1) to (5) above, in which the control unit performs control to start the output of the force sense presentation after starting the output of the pressure sense presentation.
(7)

The information processing device according to (6) above, in which after starting the output of the pressure sense presentation, the control unit performs control to start the output of the force sense presentation when a predetermined condition is satisfied.
(8)

The information processing device according to (7) above, in which the predetermined condition relates to at least one of a sink-in amount of the one part into the virtual object in the contact, an elapsed time from start of the output of the pressure sense presentation, or a pressure value in the pressure sense presentation.
(9)

The information processing device according to (8) above, in which the control unit changes a threshold used under the predetermined condition according to size or hardness information of the virtual object.
(10)

The information processing device according to any one of (7) to (9) above, in which when the predetermined condition is satisfied, the control unit performs control to start the output of the force sense presentation while maintaining a state of the pressure sense presentation at a time point when the predetermined condition is satisfied.
(11)

The information processing device according to any one of (1) to (5) above, in which the control unit performs the perception presentation control according to information regarding hardness or softness of the virtual object.
(12)

The information processing device according to (11) above, in which the control unit performs control to start the output of the force sense presentation during the output of the pressure sense presentation in a case where the virtual object is hard.
(13)

The information processing device according to (11) above, in which the control unit simultaneously starts the output of the pressure sense presentation and the force sense presentation in a case where the virtual object is hard, and temporarily fixes the output of the force sense presentation until the output of the pressure sense presentation is maximized during the pressure sense presentation.
(14)

The information processing device according to any one of (1) to (13) above, in which in a case where, after the one part comes into contact with the virtual object, another part comes into contact with the virtual object from a side facing the one part, the control unit simultaneously starts the output of the force sense presentation to the one part and the another part.
(15)

The information processing device according to any one of (1) to (14) above, in which
the control unit
performs the output of the pressure sense presentation and the output of the force sense presentation at different timings in a case where the virtual object is stationary, and
performs control such that only the output of the force sense presentation is performed in a case where the virtual object is moving.
(16)

The information processing device according to any one of (1) to (15) above, in which the control unit performs high-speed ON/OFF control of the pressure sense presentation according to information regarding a texture of the virtual object.
(17)

The information processing device according to any one of (1) to (5), above in which the control unit performs control to start the output of the pressure sense presentation after starting the output of the force sense presentation.
(18)

The information processing device according to any one of (1) to (17) above, in which the pressure sense presentation unit includes one or a plurality of pressure sense presentation actuators.
(19)

An information processing method including
a processor
performing perception presentation control according to contact with a virtual object, and
further performing, as the perception presentation control, output of pressure sense presentation by a pressure sense presentation unit and output of force sense presentation by a force sense presentation unit at different timings for at least one part of a body.
(20)

A program for causing a computer to function as a control unit that performs perception presentation control according to contact with a virtual object,
the control unit performing, as the perception presentation control, output of pressure sense presentation by a pressure sense presentation unit and output of force sense presentation by a force sense presentation unit at different timings for at least one part of a body.

### REFERENCE SIGNS LIST

10 Perception presentation device
11 Pressure sense presentation unit
12 Force sense presentation unit
20 Information processing device
210 Communication unit
220 Control unit
230 Storage unit
30 Display device
40 Camera

1. An information processing device comprising
a control unit that performs perception presentation control according to contact with a virtual object, wherein
the control unit performs, as the perception presentation control, output of pressure sense presentation by a pressure sense presentation unit and output of force sense presentation by a force sense presentation unit at different timings for at least one part of a body.

2. The information processing device according to claim 1, wherein the contact includes virtual contact between the virtual object and the one part.

3. The information processing device according to claim 2, wherein the virtual contact is contact between the virtual object displayed on a display unit and a virtual operation body displayed on the display unit and corresponding to the one part.

4. The information processing device according to claim 3, wherein the virtual operation body includes an image imitating the one part.

5. The information processing device according to claim 2, wherein the virtual contact includes contact between the virtual object superimposed and displayed in real space and the one part.

6. The information processing device according to claim 1, wherein the control unit performs control to start the output of the force sense presentation after starting the output of the pressure sense presentation.

7. The information processing device according to claim 6, wherein after starting the output of the pressure sense presentation, the control unit performs control to start the output of the force sense presentation when a predetermined condition is satisfied.

8. The information processing device according to claim 7, wherein the predetermined condition relates to at least one of a sink-in amount of the one part into the virtual object in the contact, an elapsed time from start of the output of the pressure sense presentation, or a pressure value in the pressure sense presentation.

9. The information processing device according to claim 8, wherein the control unit changes a threshold used under the predetermined condition according to size or hardness information of the virtual object.

10. The information processing device according to claim 7, wherein when the predetermined condition is satisfied, the control unit performs control to start the output of the force sense presentation while maintaining a state of the pressure sense presentation at a time point when the predetermined condition is satisfied.

11. The information processing device according to claim 1, wherein the control unit performs the perception presentation control according to information regarding hardness or softness of the virtual object.

12. The information processing device according to claim 11, wherein the control unit performs control to start the output of the force sense presentation during the output of the pressure sense presentation in a case where the virtual object is hard.

13. The information processing device according to claim 11, wherein the control unit simultaneously starts the output of the pressure sense presentation and the force sense presentation in a case where the virtual object is hard, and temporarily fixes the output of the force sense presentation until the output of the pressure sense presentation is maximized during the pressure sense presentation.

14. The information processing device according to claim 1, wherein in a case where, after the one part comes into contact with the virtual object, another part comes into contact with the virtual object from a side facing the one part, the control unit simultaneously starts the output of the force sense presentation to the one part and the another part.

15. The information processing device according to claim 1, wherein
the control unit
performs the output of the pressure sense presentation and the output of the force sense presentation at different timings in a case where the virtual object is stationary, and
performs control such that only the output of the force sense presentation is performed in a case where the virtual object is moving.

16. The information processing device according to claim 1, wherein the control unit performs high-speed ON/OFF control of the pressure sense presentation according to information regarding a texture of the virtual object.

17. The information processing device according to claim 1, wherein the control unit performs control to start the output of the pressure sense presentation after starting the output of the force sense presentation.

18. The information processing device according to claim 1, wherein the pressure sense presentation unit includes one or a plurality of pressure sense presentation actuators.

19. An information processing method comprising
a processor
performing perception presentation control according to contact with a virtual object, and
further performing, as the perception presentation control, output of pressure sense presentation by a pressure sense presentation unit and output of force sense presentation by a force sense presentation unit at different timings for at least one part of a body.

20. A program for causing a computer to function as a control unit that performs perception presentation control according to contact with a virtual object,
the control unit performing, as the perception presentation control, output of pressure sense presentation by a pressure sense presentation unit and output of force sense presentation by a force sense presentation unit at different timings for at least one part of a body.
